(19) United States
(12) Patent Application Publication
(10) Pub. No.: US 2025/0121875 A1
(43) Pub. Date: Apr. 17, 2025

(54) Ball Screw Dual Motor Power Steering

(71) Applicant: AMA Tech Corp., New Taipei City (TW)

(72) Inventor: Mao-Tu Lee, New Taipei City (TW)

(21) Appl. No.: 18/910,514

(22) Filed: Oct. 9, 2024

(30) Foreign Application Priority Data
Oct. 12, 2023 (TW) 112138836

(51) Int. Cl. B62D 5/04

(52) U.S. Cl. CPC B62D 5/0445; B62D 5/0421; B62D 5/046

(57) ABSTRACT

The present invention provides a ball screw dual-motor power steering, which includes a steering shaft, a ball bearing structure, two motors, two housings, and two controllers. The steering shaft includes a screw rod portion and a gear rack portion, and the ball bearing structure is sleeved on the screw rod portion of the steering shaft. The two motors are respectively provided at both sides of the ball bearing structure, and each includes a rotor and a stator, and the steering shaft is disposed through the rotor and the stator, and the rotor is secured to the ball bearing structure, wherein each of the two of the controllers are electrically connected to the two motors respectively. Wherein, one of the two controllers control one of the two motors to drive the rotor to rotate the ball bearing structure, and the ball bearing structure drives the steering shaft to displace along its axial direction.

### CROSS-REFERENCE TO RELATED APPLICATION

This application claims the benefit of Taiwan Patent Application No. 112138836, filed on Oct. 12, 2023, in the Taiwan Intellectual Property Office, the disclosure of which is incorporated herein in its entirety by reference.

### BACKGROUND OF THE INVENTION

### 1. Field of the Invention

The present disclosure generally relates to the field of machining devices, in particular to a ball screw dual motor power steering.

### 2. Description of the Related Art

Recirculation ball screw devices are widely used in various mechanical equipment, the main function of recirculation ball screw devices is to convert the rotary motion of the balls into linear motion, thereby the machine or object carried by the recirculation ball screw devices may move in a straight line, and may provide a precision transmission function. However, in order to allow the balls to circulate within the ball bearing, machining operations need to be performed on the bearing sleeve to form the ball grooves, and during each time of the machining operations of bearing sleeve, the ball grooves of each bearing sleeve may have deviations due to the influence of processing precision, and the deviations may cause the ball bearing to have problems such as noise, vibration, and uneven recirculation flow, and may cause serious impact on the processing precision.

Generally, a ball screw device is usually driven by a motor, and in the case of only a single motor is used for driving, when an abnormality is occurred in the motor, the driving of the ball screw device may fail, and may cause impact on the process efficiency of the overall process. Further, in the case of only the motor at one side is used for transmission, in addition to the problem of unbalanced weight in the relative position of the machine, when using a single motor to drive the screw rod, the process of transmitting the axial thrust from one end of the screw rod to the other end is relatively long, and the screw rod at the far end may have problems such as lead error and weakened driving force, and the long-term accumulation of this deviation may cause serious impact on the precision of processing.

In summary, the inventor of the present disclosure conceived and designed a ball screw dual motor power steering, which may reduce the resistance of the balls in the ball bearing structure passing through the loop rolling path, and drive the ball screw by the dual motors with respective controllers, thereby enhancing the implementation and utilization in the industry.

### SUMMARY OF THE INVENTION

In view of the above problems, the present disclosure is to provide a ball screw dual motor power steering.

To achieve the foregoing objective, the present disclosure provides a ball screw dual motor power steering comprising: a steering shaft including a screw rod portion and a gear rack portion; a ball bearing structure sleeved on the screw rod portion of the steering shaft; two motors provided at both sides of the ball bearing structure respectively, each of the two motors including a rotor and a stator, each of the rotor and the stator being provided with a hollow part through which the steering shaft is disposed, and the rotor being secured to the ball bearing structure; two housings each being tubular in structure, and one end of each of the two housings being secured to the sides of the ball bearing structure, with the steering shaft, a portion of the ball bearing structure, and the motors accommodated in the two housings; and two controllers respectively provided on the two housings, each of the two controllers configured to be electrically connected to the two motors, and the two controllers configured to be electrically connected to each other. Wherein, one of the two motors drives the rotor to rotate the ball bearing structure, and the ball bearing structure drives the steering shaft to displace along its axial direction.

In a preferred embodiment of the present disclosure, the screw rod portion may have a circular cross-section, and the gear rack portion may have a rectangular cross-section. Wherein, the ball screw dual motor power steering may further comprise a support member, which is disposed at one side of the gear rack portion, and the support member may have a rectangular groove matching the gear rack portion.

In a preferred embodiment of the present disclosure, the ball bearing structure may comprise: an inner ring member sleeved on the screw rod portion of the steering shaft, a plurality of first ball members may be provided between the inner ring member and the screw rod portion, and both sides of the inner ring member may be respectively connected with the rotors of the two motors; an outer ring member may be sleeved on the inner ring member, and a plurality of second ball members may be provided between the inner ring member and the outer ring member; and two ball circulators may be provided in the inner ring member. Wherein, each of the two ball circulators may comprise: a thread part provided at one side of the ball circulator and may have a groove corresponding to the screw rod portion to fit with the screw rod portion; a diversion part provided at the other side of the ball circulator opposite to the thread part and may have a diversion groove that is arc-shaped; and a fixing part provided at one side of the ball circulator between the thread part and the diversion part, and the fixing part may be configured to be fixed to the inner ring member.

In a preferred embodiment of the present disclosure, the first ball members may have a ball diameter, the diversion groove of the ball circulator may have a diversion curvature radius, and the diversion curvature radius may be twice the ball diameter.

In a preferred embodiment of the present disclosure, the ball screw dual motor power steering may comprise a planetary gear reducer provided between one of the two motors and the ball bearing structure, the planetary gear reducer may comprise: a drive gear member provided at one end of the rotor; a plurality of reduction gear members provided at one side of the ball bearing structure and may be meshed with the drive gear member; an inner gear member sleeved on the plurality of reduction gear members, and the inner side of the inner gear member may be meshed with the plurality of reduction gear member, an outer ring surface of the inner gear member may be provided with a flange part, and the flange part may be provided with a plurality of through holes. Wherein, the inner gear member may be combined with the ball bearing structure by the plurality of through holes, one of the two motors may drive the ball bearing structure to rotate by the planetary gear reducer, and the ball bearing structure may then drive the steering shaft to displace along the axial direction.

In summary, the present disclosure provides a ball screw dual motor power steering, wherein the ball bearing structure of the ball screw dual motor power steering may have an independently arranged ball circulator. In comparison to the conventional bearing sleeve, which is subjected to a machining process to form the ball groove, the ball circulator of the ball bearing structure of the present disclosure may be independently mass-produced and subsequently installed into the ball bearing structure, thereby reducing the error of its diversion groove during the production process of the ball circulator, and may reduce the manufacturing cost of forming a loop rolling path. Further, the ball screw dual motor power steering of the present disclosure may effectively avoid problems such as noise, vibration, and uneven recirculation flow, and may improve the processing precision. In addition, the diversion curvature radius of the diversion groove of the ball circulator of the ball bearing structure of the present disclosure may be configured to be twice the ball diameter of the ball member, thereby may further avoid the problems such as noise, vibration, and uneven recirculation flow that may occur during the uneven recirculation process.

In addition, the ball screw dual motor power steering of the present disclosure may be provided with motors on both sides of the ball bearing structure to cooperate with respective controllers to drive the ball screw dual motor power steering by the dual motor structure. Through this configuration, when any one of the controllers detects an abnormality in the motor, the controller may immediately shut down the abnormal motor, and the other controller may start the normal motor for continues operation. Therefore, in the case of an abnormality is occurred in the motors, the ball screw dual motor power steering of the present disclosure may still operate normally as a whole, thereby improving the operating efficiency of the motors and reducing the possible dangers caused by equipment abnormalities.

### BRIEF DESCRIPTION OF THE DRAWINGS

The features and technical contents of the present disclosure will be further appreciated and understood with reference to the detailed description of preferred embodiments and accompanying drawings.

FIG. 1 is a schematic diagram of a partial structure of the ball screw dual motor power steering in accordance with an embodiment of the present disclosure.

FIG. 2 is a schematic diagram of the appearance of the ball screw dual motor power steering in accordance with an embodiment of the present disclosure.

FIG. 3 is a schematic diagram of the steering shaft of the ball screw dual motor power steering in accordance with an embodiment of the present disclosure.

FIG. 4 is a schematic diagram of the gear rack portion of the steering shaft and the vortex rod of the ball screw dual motor power steering in accordance with an embodiment of the present disclosure.

FIG. 5 is a schematic diagram of the ball bearing structure of the ball screw dual motor power steering in accordance with an embodiment of the present disclosure.

FIG. 6 is a schematic diagram of an internal structure of the ball bearing structure of the ball screw dual motor power steering in accordance with an embodiment of the present disclosure.

FIG. 7A to FIG. 7D are schematic diagrams of the ball circulator of the ball bearing structure of the ball screw dual motor power steering in accordance with an embodiment of the present disclosure.

### DETAILED DESCRIPTION OF THE PREFERRED EMBODIMENTS

In order to facilitate the understanding of the technical features, contents and advantages of the present disclosure and the effective thereof that can be achieved, the present disclosure will be illustrated in detail below in the form of embodiments with the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

It is noted that terms such as “first” and “second” may be used herein to describe various components, members, regions, sections, layers, and/or sites. However, the components, members, regions, sections, layers and/or sites are not limited thereto. The above terms are only used to distinguish one component, member, region, section, layer and/or site from another component, member, region, section, layer and/or site. Hens, the “first” component, the “first” member, the “first” region, the “first” section, the “first” layer, and/or the “first” site may also be called the “second” component, the “second” member, the “second” region, the “second” section, the “second” layer, and/or the “second” site without deviating the spirits and the teachings of the present disclosure.

Unless otherwise defined, all terms (including technical and scientific terms) used herein may have the same meanings as commonly understood by those skilled in the art. It is also noted that the terms such as commonly used dictionary definitions will be interpreted to have definitions consistent with meanings in the context of the relevant art and the present invention, and will not to be interpreted in an idealized or overly formal sense unless explicitly defined herein.

The advantages, features, and technical methods of accomplishing the present disclosure will be more easily understood by being described in more detail with reference to the exemplary embodiments and the accompanying drawings, and the present disclosure may be implemented in different forms, so it should not be construed as being limited to the content described herein. Rather, these embodiments are provided as examples so that this disclosure will be thorough and complete, and will fully convey the aspects of the present disclosure to those skilled in the art, and the present disclosure will only be defined by the appended claims.

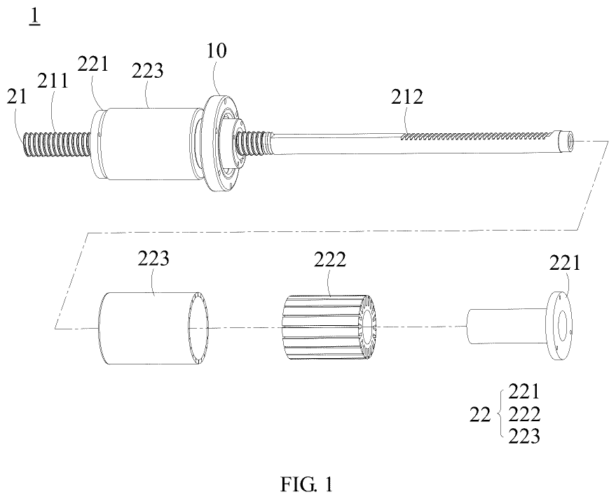

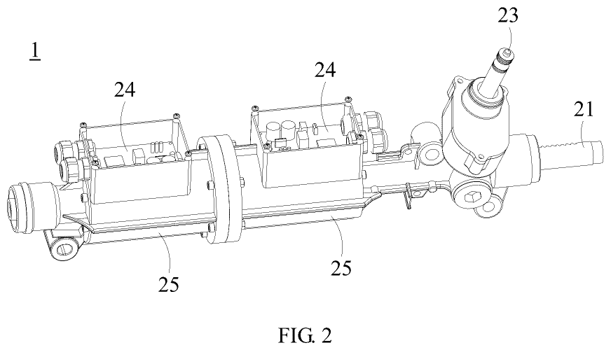

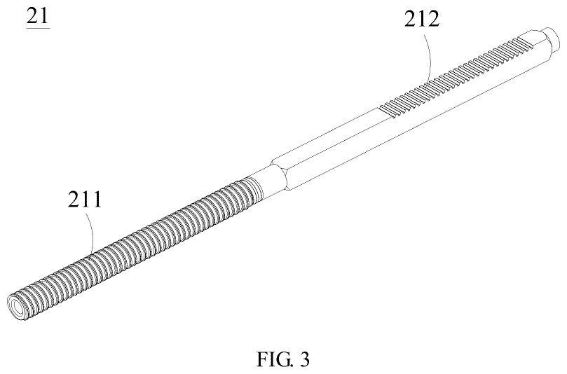

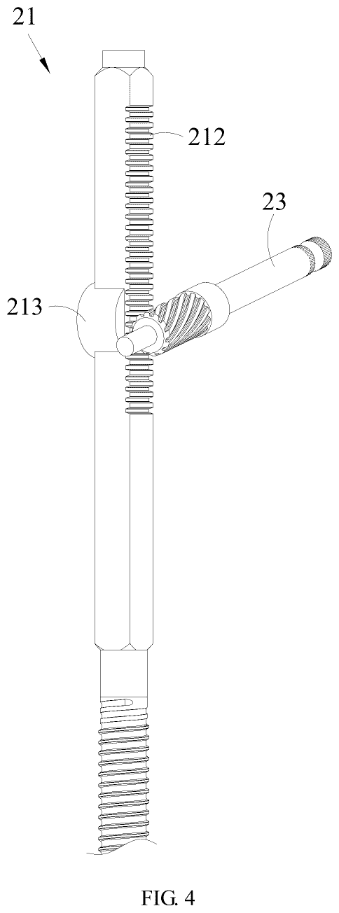

Referring to FIG. 1 to FIG. 4, FIG. 1 is a schematic diagram of a partial structure of the ball screw dual motor power steering in accordance with an embodiment of the present disclosure, FIG. 2 is a schematic diagram of the appearance of the ball screw dual motor power steering in accordance with an embodiment of the present disclosure, FIG. 3 is a schematic diagram of the steering shaft of the ball screw dual motor power steering in accordance with an embodiment of the present disclosure, and FIG. 4 is a schematic diagram of the gear rack portion of the steering shaft and the vortex rod of the ball screw dual motor power steering in accordance with an embodiment of the present disclosure.

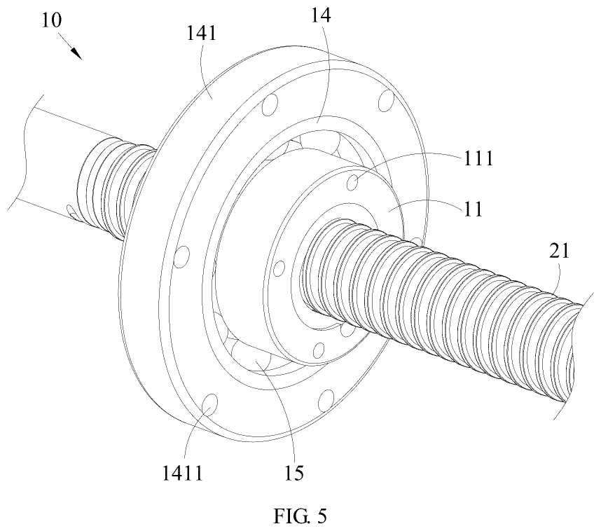

As shown in FIG. 1 to FIG. 3, the present disclosure provides a ball screw dual motor power steering 1, which may comprise a steering shaft 21, a ball bearing structure 10, a two motors 22, two housings 25 and two controllers 24. The steering shaft 21 may include a screw rod portion 211 and a gear rack portion 212. The ball bearing structure 10 may be sleeved on the screw rod portion 211 of the steering shaft 21. Each of the two motors 22 may include a rotor 223 and a stator 221. Each of the rotor 223 and the stator 221 may be hollow in structure, such that the steering shaft 21 may be disposed through a hollow part of the rotor 223 and stator 221. The rotor 223 may be secured to the ball bearing structure 10. Wherein, one of the two motors 22 may drive the rotor 223 to rotate the ball bearing structure 10, and the ball bearing structure 10 may then drive the steering shaft 21 to displace along its axial direction. Wherein, the detailed structure of the ball bearing structure 10 will be set forth below with reference to FIG. 5 to FIG. 7D, in which the technical features of the ball screw dual motor power steering 1 are mainly disclosed.

Specifically, in the present embodiment, as shown in FIG. 1 and FIG. 2, the ball screw dual motor power steering 1 of the present disclosure uses an external-rotor motor as the motor 22. One end of the rotor 223 of the motor 22 may be secured to the through holes 111 on one side of the inner ring member 11, thereby driving the ball bearing structure 10 to rotate when the motor 22 drives the rotor 223 to rotate. The ball bearing structure 10 may then drive the steering shaft 21 to displace along its axial direction without rotating. In Although not explicitly shown in FIG. 1, connecting members, such as screws and threaded sleeves, may be provided between the motor 22 and the ball bearing structure 10, and the present disclosure is not limited to the above embodiments. For example, in other embodiments, a suitable type of driving source such as an external-rotor motor, an internal-rotor motor, or a belt motor may be used as the motor, and the connection method between the motor and the ball bearing structure or between the motor and the steering shaft may also be configured according to requirement.

In addition, as shown in FIG. 1 and FIG. 2, in the ball screw dual motor power steering 1 of the present disclosure, the two controllers 24 may be electrically connected to the two motors 22 respectively, and the two controllers 24 are electrically connected to each other. Wherein, the two motors 22 provided at both sides of the ball bearing structure may be referred to as a first motor and a second motor respectively, and the two controllers 24 may be referred to as a first controller and a second controller respectfully corresponding to the first motor and the second motor. Further, the first controller may be electrically connected to the first motor, the second controller may be electrically connected to the second motor, and the first controller and the second controller may be electrically connected to each other. Through this configuration, when any one of the controllers 24 detects an abnormality in the motor 22 it controls, this controller 24 may shut down the abnormal motor 22 in time, and may transmit a signal to the other controller 24, thereby allowing the other controller 24 to start the normal motor 22 and continue the operation. Therefore, when abnormalities occurred in one of the motors 22, the whole ball screw dual motor power steering 1 may still operate normally.

Further, as shown in FIG. 3, in the present embodiment, one part of the steering shaft 21 may be the screw rod portion 211 having a threaded groove, and the other part may be the gear rack portion 212 having a tooth row. Wherein, the screw rod portion 211 may have a circular cross-section, and the gear rack portion 212 may have a rectangular cross-section.

In addition, as shown in FIG. 4, the ball screw dual motor power steering 1 may further include a vortex rod 23, which meshes with the gear rack portion 212 of the steering shaft 21. When the motor 22 drives the steering shaft 21 to reciprocate, the gear rack portion 212 of the steering shaft 21 may drive the vortex rod 23, such that the vortex rod 23 may be used as an output link to connect with other mechanical components for further applications.

Furthermore, the ball screw dual motor power steering 1 may comprise a support member 213, which is disposed at one side of the gear rack portion 212. The support member 213 may have a rectangular groove matching the shape of the gear rack portion 212. The rectangular groove of the support member 213 may accommodate the gear rack portion 212, and the other side of the support member 213 opposite to the rectangular groove may be disposed against the housing 25. Through this configuration, when the ball screw dual motor power steering 1 is operated to displace the steering shaft 21 along its axial direction, the support member 213 may provide support to the gear rack portion 212 to reduce the deviation during the moving of the steering shaft 21, thereby improving the precision of the dual motor power steering 1 and reducing the possibility of damages to the components. In the present embodiment, the support member 213 is made of copper material.

In addition, the two housings 25 of the ball screw dual motor power steering 1 may be referred to as a first housing and a second housing. The two housings 25 are each tubular in structure. One of the two housings 25 may have one end secured to one side of the support flange 141 of the ball bearing structure 10. And the other of the two housings 25 may have one end secured to the other side of the support flange 141 of the ball bearing structure 10. Wherein, at least a portion of the ball bearing structure 10, the steering shaft 21, the two motors 22, the vortex rod 23, and the two controllers 24 may be accommodated in the accommodation space formed by the first housing and the second housing. And both ends of the steering shaft 21 may extend from the first housing and the second housing respectively.

It should be noted that, in the case of the ball screw dual motor power steering 1 of the present disclosure is required to provide large torque, the ball screw dual motor power steering 1 may further comprise a planetary gear reducer provided between the motors 22 and the ball bearing structure 10, for reducing the rotational speed of motors 22 and increasing the torque of motors 22. Specifically, the planetary gear reducer comprises: a drive gear member provided at one end of the rotor 223; a plurality of reduction gear members provided at one side of the ball bearing structure 10 and engaged with the drive gear member; an inner gear member sleeved on the plurality of reduction gear member, and the inner side of the inner gear member engaged with the plurality of reduction gear member, an outer ring surface of the inner gear member is provided with a flange part, and the flange part is provided with a plurality of through holes. Wherein, the inner gear member is combined with the ball bearing structure 10 by the plurality of through holes. In the case of the planetary gear reducer is provided, when one of the two motors 22 is operated, the motor 22 may drive the ball bearing structure 10 to rotate through the planetary gear reducer, and the ball bearing structure 10 drives the steering shaft 21 to displace along the its axial direction.

In an embodiment of the present disclosure, only a single motor 22 may be provided with a planetary gear reducer, and the present disclosure is not limited thereto. In the case of the motors 22 are provided at both sides of the ball bearing structure 10, two planetary gear reducers may be provided between the two motors 22 and the ball bearing structure 10 respectively, or the planetary gear reducer may be omitted. That is, the number of planetary gear reducers may be arranged according to requirements or cost considerations.

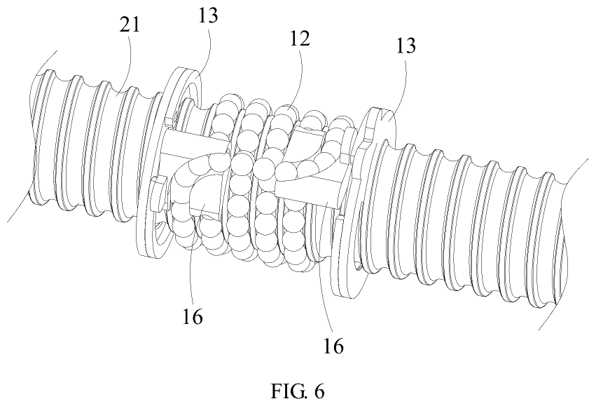

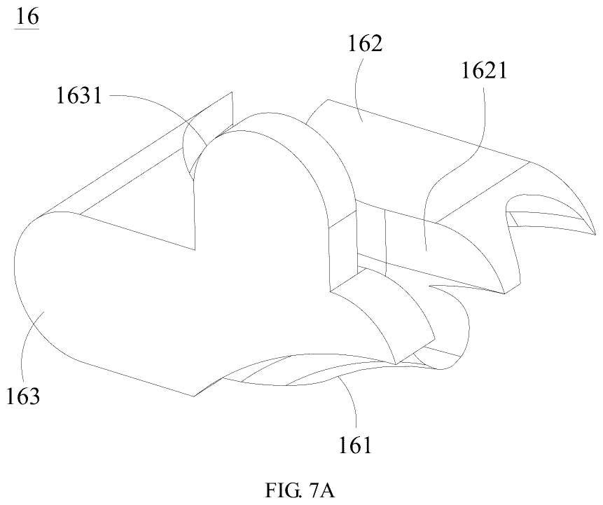

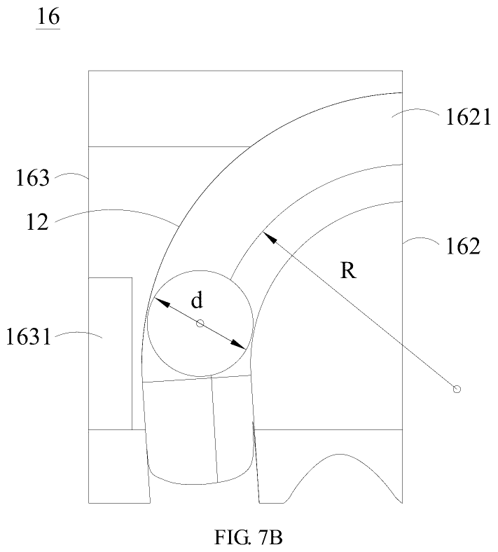

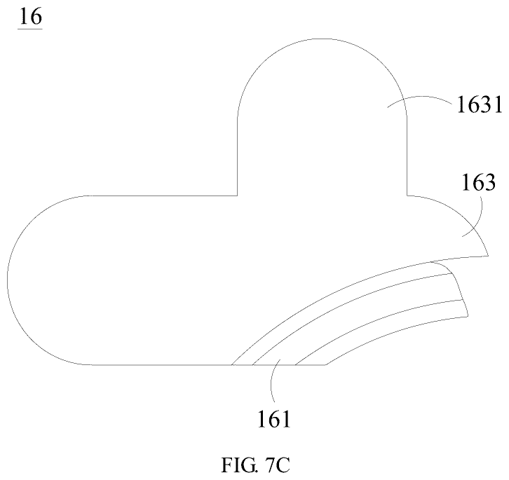

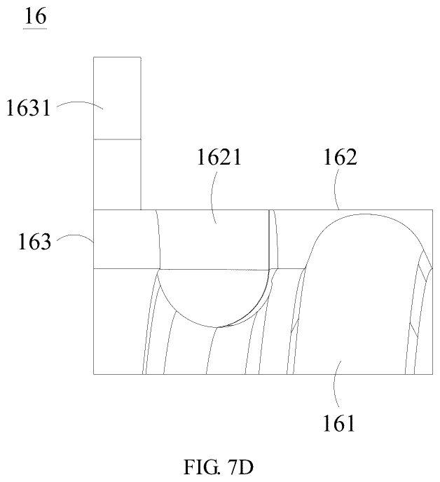

Referring to FIG. 5 to FIG. 7D, FIG. 5 is a schematic diagram of the ball bearing structure of the ball screw dual motor power steering in accordance with an embodiment of the present disclosure, FIG. 6 is a schematic diagram of an internal structure of the ball bearing structure of the ball screw dual motor power steering in accordance with an embodiment of the present disclosure, and FIG. 7A to FIG. 7D are schematic diagrams of the ball circulator of the ball bearing structure of the ball screw dual motor power steering in accordance with an embodiment of the present disclosure.

As shown in FIG. 5 and FIG. 6, the ball bearing structure 10 according to the present disclosure may further include an inner ring member 11, two inner ring spacers 13, an outer ring member 14 and two ball circulators 16. The inner ring member 11 may be sleeved on the screw rod portion 211 of the steering shaft 21. The inner ring member 11 may be provided with a plurality of through holes 111. And a plurality of first ball members 12 may be disposed between the inner ring member 11 and the screw rod portion 211. The two inner ring spacers 13 may be provided at both sides of the inner ring member 11. The outer ring member 14 may be sleeved on the inner ring member 11. The outer ring surface of the outer ring member 14 may be provided with a support flange 141. The support flange 141 may be provided with a plurality of through holes 1411. And a plurality of second ball members 15 may be provided between the inner ring member 11 and the outer ring member 14. The two ball circulators 16 may be provided to the inner ring member 11.

Specifically, as shown in FIG. 7A to FIG. 7D, FIG. 7A is a schematic diagram of the appearance of the ball circulator 16; FIG. 7A is a top-view of the ball circulator 16, which mainly shows the shape of the diversion groove 1621 of the ball circulator 16; FIG. 7C is a side view of the ball circulator 16, which mainly shows the shape of the fixing part 163 of ball circulator 16; and FIG. 7D is another side view of the ball circulator 16, which mainly shows the shapes of the diversion groove 1621 and thread part 161 of the ball circulator 16.

Wherein, each of the two ball circulators 16 may comprise a thread part 161, a diversion part 162 and a fixing part 163. The thread part 161 may be provided at one side of the ball circulator 16 and may have a groove corresponding to the screw rod portion 211 to be fitted with the screw rod portion 211. The diversion part 162 may be provided at the other side of the ball circulator 16 opposite to the thread part 161 and may have a diversion groove 1621 that is arc-shaped. The fixing part 163 may be provided at one side of the ball circulator 16 between the thread part 161 and the diversion part 162. The fixing part 163 may be configured to be fixed to inner ring spacer 13 at one side of the inner ring member 11. Wherein, the two diversion grooves 1621 of the two ball circulators 16 and the spiral groove of the screw rod portion 211 of the steering shaft 21 together may form the loop rolling path for the plurality of first ball members 12.

Referring again to FIG. 6, the extension directions of the two end openings of the diversion groove 1621 of the diversion part 162 of the ball circulator 16 may be perpendicular to each other. The end opening of the diversion groove 1621 of one ball circulator 16 may be corresponding to the end opening of the diversion groove 1621 of the other ball circulator 16 Consequently, the plurality of first ball members 12, such as the balls, may move cyclically along the diversion groove 1621 of the two ball circulators 16 and the spiral groove structure of the screw rod portion 211 of the steering shaft 21, and thus forming the loop rolling path for the plurality of first ball members 12.

In addition, in the present embodiment, the fixing part 163 of the ball circulator 16 may be provided with a fixing bump 1631 protruding along the plane extending direction of the fixing part 163, and the fixing bump 1631 may be flat in shape to lean against the inner ring spacer 13, such that the ball circulator 16 may be fixed on the inner ring spacer 13 more firmly.

Furthermore, as shown in FIG. 7B, the diversion groove 1621 of the diversion part 162 may be arc-shaped, and the curvature radius of the diversion groove 1621 may be configured according to the size of the plurality of first ball members 12. For example, the plurality of first ball members 12 may have a ball diameter d, and the diversion groove 1621 of the diversion part 162 of ball circulator 16 may have a diversion curvature radius R, and the diversion curvature radius R may be configured to twice the ball diameter d, that is, R=2d. Through this configuration, the resistance of the plurality of first ball members 12 when passing through the diversion groove 1621 may be effectively reduced, thereby reducing noise, vibration and uneven recirculation flow during the recirculation process of the first ball members 12.

In the ball bearing structure 10 of the present disclosure, the ball circulator 16 may be independently mass-produced and subsequently installed into the ball bearing structure 10, and thus the ball circulators 16 with different specifications may be produced based on requirements. In addition, the production parameters may be adjusted based on the specifications of each ball circulator 16, thereby reducing the error of the diversion groove 1621 of the ball circulator 1, and may reduce the manufacturing cost of forming a loop rolling path.

In addition, the ball screw dual motor power steering 1 may comprise a support member 213, which may be disposed at one side of the gear rack portion 212, and the support member 213 may have a rectangular groove matching the gear rack portion 212. The rectangular groove of the support member 213 may accommodate the gear rack portion 212, and the other side of the rectangular groove may be disposed against the housing 25. Through this configuration, when the ball screw dual motor power steering 1 is operated to displace the steering shaft 21 along its axial direction, the support member 213 may provide support to the gear rack portion 212 to reduce the deviation during the moving of the steering shaft 21, thereby improving the precision of the dual motor power steering 1 and reducing the chance of damage occurred in components. In the present embodiment, the support member 213 is made of copper material.

In summary, the present disclosure provides a ball screw dual motor power steering, wherein the ball bearing structure of the ball screw dual motor power steering has an independently arranged ball circulator. In comparison to the conventional bearing sleeve, which is subjected to a machining process to form the ball groove, the ball circulator of the ball bearing structure of the present disclosure may be independently mass-produced and subsequently installed into the ball bearing structure, thereby reducing the error of its diversion groove during the production process of the ball circulator, and may reduce the manufacturing cost of forming a loop rolling path. Further, the ball screw dual motor power steering of the present disclosure may effectively avoid problems such as noise, vibration, and uneven recirculation flow, and may improve the processing precision. In addition, the diversion curvature radius of the diversion groove of the ball circulator of the ball bearing structure of the present disclosure may be configured to be twice the ball diameter of the ball member, thereby may further avoid the problems such as noise, vibration, and uneven recirculation flow that may occur during the uneven recirculation process.

In addition, the ball screw dual motor power steering of the present disclosure may be provided with motors on both sides of the ball bearing structure to cooperate with respective controllers to drive the ball screw dual motor power steering by the dual motor structure. Through this configuration, when any one of the controllers detects an abnormality in the motor, the controller may immediately shut down the abnormal motor, and the other controller may start the normal motor for continues operation. Therefore, in the case of an abnormality is occurred in the motors, the ball screw dual motor power steering of the present disclosure may still operate normally as a whole, thereby improving the operating efficiency of the motors and reducing the possible dangers caused by equipment abnormalities.

The above-mentioned embodiments are only to illustrate the technical concept and features of the present disclosure, and for those having ordinary skill in the art to understand the content of the present disclosure and implement the present disclosure accordingly. It should not be construed as limiting the scope of the present disclosure. It is to be construed that all changes or modifications derived from the spirit of the present disclosure are included in the scope of the disclosure.

What is claimed is:

1. A ball screw dual motor power steering, comprising:
a steering shaft including a screw rod portion and a gear rack portion;
a ball bearing structure sleeved on the screw rod portion of the steering shaft;
two motors provided at both sides of the ball bearing structure respectively, each of the two motors including a rotor and a stator, each of the rotor and the stator being provided with a hollow part through which the steering shaft is disposed, and the rotor being secured to the ball bearing structure;
two housings each being tubular in structure, and one end of each of the two housings being secured to one of the sides of the ball bearing structure, with the steering shaft, a portion of the ball bearing structure, and the motors accommodated in the two housings; and
two controllers respectively provided on the two housings, each of the two controllers configured to be electrically connected to the two motors, and the two controllers configured to be electrically connected to each other;
wherein one of the two motors drives the rotor to rotate the ball bearing structure, and the ball bearing structure drives the steering shaft to displace along an axial direction thereof.

2. The ball screw dual motor power steering of claim 1, wherein the screw rod portion has a circular cross-section, and the gear rack portion has a rectangular cross-section;
wherein, the ball screw dual motor power steering further comprises a support member, which is disposed at one side of the gear rack portion, and the support member includes a rectangular groove matching the gear rack portion.

3. The ball screw dual motor power steering of claim 1, the ball bearing structure comprising:
an inner ring member sleeved on the screw rod portion of the steering shaft, a plurality of first ball members being provided between the inner ring member and the screw rod portion, and both sides of the inner ring member being respectively connected with the rotors of the two motors;
an outer ring member sleeved on the inner ring member, and a plurality of second ball members being provided between the inner ring member and the outer ring member; and
two ball circulators provided to the inner ring member, and each of the two ball circulators comprising:
a thread part provided at one side of the ball circulator and having a groove corresponding to the screw rod portion to be fitted thereto;
a diversion part provided at one other side of the ball circulator opposite to the thread part and having a diversion groove being arc-shaped; and
a fixing part provided at another side of the ball circulator between the thread part and the diversion part, and the fixing part being configured to be fixed to the inner ring member.

4. The ball screw dual motor power steering of claim 3, wherein the first ball members each has a ball diameter, the diversion groove of the ball circulator has a diversion curvature radius, and the diversion curvature radius is twice the ball diameter.
